(19) United States
(12) Patent Application Publication
(10) Pub. No.: US 2025/0378521 A1
(43) Pub. Date: Dec. 11, 2025

(54) METHOD OF PROCESSING IMAGE, ELECTRONIC DEVICE, AND STORAGE MEDIUM

(71) Applicant: BOE Technology Group Co., Ltd., Beijing (CN)

(72) Inventors: Feng HOU, Beijing (CN); Hao FANG, Beijing (CN)

(21) Appl. No.: 18/994,978

(22) PCT Filed: Apr. 16, 2024
(86) PCT No.: PCT/CN2024/087982

§ 371 Date: Jan. 15, 2025

(30) Foreign Application Priority Data
May 31, 2023 (CN) 202310638599.0

(51) Int. Cl. G06T 1/00

(52) U.S. Cl. CPC G06T 1/0021

(57) ABSTRACT

Provided is a method of processing an image, an electronic device, and a storage medium. The method of processing an image includes: encoding a first to-be-encoded information corresponding to a display apparatus, so as to obtain a first encoded information; adjusting a pixel value of at least one first predetermined region of a to-be-encoded image according to the first encoded information, so as to obtain a first encoded image, wherein the to-be-encoded image corresponds to a target image; and fusing the target image with the first encoded image to obtain a fused image.

### CROSS REFERENCE TO RELATED APPLICATION

This application is a Section 371 National Stage Application of International Application No. PCT/CN2024/087982, filed on Apr. 16, 2024, entitled “METHOD OF PROCESSING IMAGE, ELECTRONIC DEVICE, AND STORAGE MEDIUM”, and published as WO 2024/244729 A1, published Dec. 12, 2024, not in English, which claims priority to Chinese Patent Application No. 202310638599.0 filed on May 31, 2023, the contents of which are incorporated herein by reference in their entireties.

### TECHNICAL FIELD

The present disclosure relates to a field of image processing technology, and in particular to a method of processing an image, an electronic device and a storage medium.

### BACKGROUND

With a continuous development of a computer technology and a network technology, paperless and electronic office is gradually popularized, and various electronic devices with display screens are used more and more widely. Such electronic devices are mainly used for writing and document display in daily office, meetings and other occasions.

Although the use of such electronic devices may bring convenience to people's daily office work, the use of such electronic devices for writing and document display in some office or meeting occasions where confidentiality is required may easily cause an information leakage.

### SUMMARY

According to a first aspect, the present disclosure provides a method of processing an image, including: encoding a first to-be-encoded information corresponding to a display apparatus, so as to obtain first encoded information; adjusting a pixel value of at least one first predetermined region of a to-be-encoded image according to the first encoded information, so as to obtain a first encoded image, wherein the to-be-encoded image corresponds to a target image;

and fusing the target image with the first encoded image to obtain a fused image.

For example, the first encoded information includes a first encoding code of at least one bit; and the adjusting a pixel value of at least one first predetermined region of a to-be-encoded image corresponding to a target image according to the first encoded information, so as to obtain a first encoded image includes: adjusting the pixel value of the at least one first predetermined region of the to-be-encoded image according to at least one first predetermined pixel value, so as to obtain the first encoded image, wherein at least one first predetermined region of the first encoded image comprises the at least one first predetermined pixel value, and the at least one first predetermined pixel value corresponds to the at least one bit of the first encoding code respectively.

For example, the first encoding code is a N-bit code, where N is a positive integer; and the adjusting the pixel value of the at least one first predetermined region of the to-be-encoded image according to at least one first predetermined pixel value so as to obtain the first encoded image comprises: for each of the at least one first predetermined region, dividing the first predetermined region into N first predetermined sub-regions, wherein the N first predetermined sub-regions comprise N1 first encoding sub-regions and N2 second encoding sub-regions, the N-bit first encoding code comprises a N1-bit first encoding code and a N2-bit second encoding code, where N1 and N2 are natural numbers, each bit of the N1-bit first encoding code corresponds to one first predetermined pixel value, and each bit of the N2-bit second encoding code corresponds to more than one first predetermined pixel values: adjusting, based on a first encoding strategy, pixel values of the NI first encoding sub-regions of the to-be-encoded image according to the first predetermined pixel value corresponding to each bit of the N1-bit first encoding code, so as to obtain NI first encoding region images; adjusting, based on a second encoding strategy, pixel values of the N2 second encoding sub-regions of the to-be-encoded image according to the first predetermined pixel values corresponding to each bit of the N2-bit second encoding code, so as to obtain N2 second encoding region images; and obtaining the first encoded image according to the N1 first encoding region images and the N2 second encoding region images.

For example, the adjusting, based on a first encoding strategy, pixel values of the N1 first encoding sub-regions of the to-be-encoded image according to a first predetermined pixel value corresponding to the N1-bit first encoding code, so as to obtain N1 first encoding region images includes: for each of the N1 first encoding sub-regions, determining a first encoding code corresponding to the first encoding sub-region, so as to obtain a first target encoding code corresponding to the first encoding sub-region: and adjusting the pixel value of the first encoding sub-region to a first predetermined pixel value corresponding to the first target encoding code, so as to obtain the first encoding region image corresponding to the first encoding sub-region,

For example, the plurality of first predetermined pixel values include a first predetermined encoding pixel value and at least one second predetermined encoding pixel value, and the first predetermined encoding pixel value is greater than the at least one second predetermined encoding pixel value; and the adjusting, based on a second encoding strategy, pixel values of the N2 second encoding sub-regions of the to-be-encoded image according to the first predetermined pixel values corresponding to the N2-bit second encoding code, so as to obtain N2 second encoding region images includes: for each of the N2 second encoding sub-regions, determining a second encoding code corresponding to the second encoding sub-region, so as to obtain a second target encoding code corresponding to the second encoding sub-region; determining a first predetermined ratio corresponding to the second target encoding code according to a first predetermined association relationship set, where the first predetermined association relationship set includes N2 first predetermined association relationships, and each of the first predetermined association relationships characterizes an association relationship between the second encoding code and the first predetermined ratio; and adjusting a pixel value of a first encoding region in the second encoding sub-region to the first predetermined encoding pixel value according to the first predetermined ratio, and adjusting a pixel value of a second encoding region in the second encoding sub-region to the at least one second predetermined encoding pixel value according to the first predetermined ratio, so as to obtain the second encoding region image corresponding to the second encoding sub-region, where a ratio between a size information of the first encoding region and a size information of the second encoding sub-region is the first predetermined ratio.

For example, the method further includes: determining a second predetermined association relationship corresponding to each of the N1 first encoding sub-regions, so as to obtain a second predetermined association relationship set, where the second predetermined association relationship set includes N1 second predetermined association relationships, each of the second predetermined association relationships characterizes an association relationship between a first predetermined region identifier and a first predetermined strategy identifier, the first predetermined region identifier is configured to characterize the first encoding sub-region, and the first predetermined strategy identifier characterizes that an encoding strategy corresponding to the first encoding sub-region is the first encoding strategy; determining a third predetermined association relationship corresponding to each of the N2 second encoding sub-regions, so as to obtain a third predetermined association relationship set, where the third predetermined association relationship set includes N2 third predetermined association relationships, each of the third predetermined association relationship characterizes an association relationship between a second predetermined region identifier and a second predetermined strategy identifier, the second predetermined region identifier is configured to characterize the second encoding sub-region, and the second predetermined strategy identifier characterizes that an encoding strategy corresponding to the second encoding sub-region is the second encoding strategy: and storing the second predetermined association relationship set and the third predetermined association relationship set.

For example, the first to-be-encoded information includes a multi-bit first to-be-encoded code; and the encoding a first to-be-encoded information corresponding to a display apparatus so as to obtain first encoded information includes: dividing the multi-bit first to-be-encoded code into a plurality of first to-be-encoded groups; determining a first check code corresponding to each of the plurality of first to-be-encoded groups, so as to obtain a plurality of first check codes; and obtaining the first encoded information according to the multi-bit first to-be-encoded code and the plurality of first check codes.

For example, the fusing the target image with the first encoded image to obtain a fused image includes: determining a product between a pixel value of each of at least one pixel included in the target image and a first predetermined coefficient, so as to obtain a first pixel information; determining a product between a pixel value of each of at least one pixel included in the first encoded image and a second predetermined coefficient, so as to obtain a second pixel information; obtaining a third pixel information according to the first pixel information and the second pixel information; and obtaining the fused image according to the third pixel information.

For example, a shape of the first predetermined region includes at least one of; a rectangle, a square, a diamond, a triangle or a circle.

For example, a shape of the first encoding sub-region includes at least one of; a rectangle, a square, a diamond, a triangle, and a circle; and a shape of the second encoding sub-region includes at least one of: a rectangle, a square, a diamond, a triangle or a circle.

For example, the first to-be-encoded information includes at least one of: a device identifier, a time displayed on the display apparatus or a geographical location.

According to a second aspect, the present disclosure provides a method of processing an image, including: processing a to-be-processed image to obtain a second encoded image, where the to-be-processed image includes one of: a fused image or a captured image corresponding to the fused image, and the fused image is obtained by the method according to any one of claims 1 to 11; obtaining second encoded information according to a pixel value of at least one second predetermined region of the second encoded image; and decoding the second encoded information to obtain second to-be-encoded information corresponding to a display apparatus.

For example, the obtaining second encoded information according to a pixel value of at least one second predetermined region of the second encoded image includes: determining a second encoding code corresponding to each of the at least one second predetermined region of the second encoded image, according to at least one second predetermined pixel value, so as to obtain the second encoded information, wherein the at least one second predetermined pixel value corresponds to the at least one second predetermined region of the second encoded image respectively.

For example, the second encoding code is a N-bit code, the N-bit second encoding code includes a N1-bit first encoding code and a N2-bit second encoding code, where N is a positive integer, and N1 and N2 are natural numbers; the determining a second encoding code corresponding to each of the at least one second predetermined region of the second encoded image according to at least one second predetermined pixel value so as to obtain the second encoded information includes: determining the at least one second predetermined region corresponding to the second encoded image and N1 first decoding sub-regions and N2 second decoding sub-regions respectively corresponding to the at least one second predetermined region; and for each of the at least one second predetermined region, obtaining the second encoded information by; obtaining, based on a first decoding strategy, a first decoded information according to a second predetermined pixel value corresponding to each of the N1 first decoding sub-regions and a plurality of second predetermined pixel values respectively corresponding to the N2 second decoding sub-regions; when it is determined that the first decoded information includes a first target decoding code corresponding to each of the N1 first decoding sub-regions and does not include a second target decoding code corresponding to each of the N2 second decoding sub-regions, obtaining, based on a second decoding strategy, a second decoded information according to the plurality of second predetermined pixel values respectively corresponding to the N2 second decoding sub-regions of the second predetermined region; and when it is determined that the second decoded information includes the second target decoding code corresponding to each of the N2 second decoding sub-regions, obtaining the N-bit second encoding code according to a N1-bit first target decoding code and a N2-bit second target decoding code; or obtaining, based on the second decoding strategy, a third decoded information according to a second predetermined pixel value corresponding to each of the N1 first decoding sub-regions and a plurality of second predetermined pixel values respectively corresponding to the N2 second decoding sub-regions; when it is determined that the third decoded information includes a second target decoding code corresponding to each of the N2 second decoding sub-regions and does not include a first target decoding code corresponding to each of the NI first decoding sub-regions, obtaining, based on the first decoding strategy, a fourth decoded information according to a second predetermined pixel value corresponding to each of the N1 first decoding sub-regions of the second predetermined region; and when it is determined that the fourth decoded information includes the first target decoding code corresponding to each of the N1 first decoding sub-regions, obtaining a N-bit second encoding code according to the N1-bit first target decoding code and the N2-bit second target decoding code.

For example, the second encoding code is a N-bit code, the N-bit second encoding code includes a N1-bit first decoding code and a N2-bit second decoding code, where N is a positive integer, and N1 and N2 are natural numbers; and the determining a second encoding code corresponding to each of the at least one second predetermined region of the second encoded image, according to at least one second predetermined pixel value so as to obtain the second encoded information includes: determining at least one second predetermined region corresponding to the second encoded image and NI first decoding sub-regions and N2 second decoding sub-regions respectively corresponding to the at least one second predetermined region; and for each of the at least one second predetermined region, determining a decoding strategy corresponding to each of the N1 first decoding sub-regions of the second predetermined region and a decoding strategy corresponding to each of N second decoding sub-regions of the second redetermined region, so as to obtain a first decoding strategy corresponding to each of the N1 first decoding sub-regions and a second decoding strategy corresponding to each of the N2 second decoding sub-regions; obtaining, based on the first decoding strategy, a first target decoding code corresponding to each of the N1 first decoding sub-regions according to a second predetermined pixel value corresponding to each of the N1 first decoding sub-regions of the second predetermined region; obtaining, based on the second decoding strategy, a second target decoding code corresponding to each of the N2 second decoding sub-regions according to a plurality of second predetermined pixel values corresponding to each of the N2 second decoding sub-regions of the second predetermined region; and obtaining the N-bit second encoding code according to a N1-bit first target decoding code and a N2-bit second target decoding code.

For example, the plurality of second predetermined pixel values include a first decoding predetermined pixel value and at least one second decoding predetermined pixel value, and the first decoding predetermined pixel value is greater than any one of the at least one second decoding predetermined pixel value; and the obtaining, based on the second decoding strategy, a second target decoding code corresponding to each of the N2 second decoding sub-regions according to a plurality of second predetermined pixel values corresponding to each of the N2 second decoding sub-regions of the second predetermined region includes: for each second of the N2 second decoding sub-regions, determining a first decoding region in the second decoding sub-region according to a first decoding predetermined pixel value corresponding to the second decoding sub-region; determining a ratio between a size information of the first decoding region and a size information of the second decoding sub-region, so as to obtain a second predetermined ratio corresponding to the second decoding sub-region; and determining a second decoding code corresponding to the second predetermined ratio according to a first predetermined association relationship set, so as to obtain the second target decoding code corresponding to the second predetermined sub-region, where the first predetermined association relationship set includes N2 first predetermined association relationships, and each of the first predetermined association relationships characterizes an association relationship between the second decoding code and the second predetermined ratio.

For example, the determining a decoding strategy corresponding to each of the N1 first decoding sub-regions of the second predetermined region and a decoding strategy corresponding to each of N second decoding sub-regions of the second predetermined region, so as to obtain a first decoding strategy corresponding to each of the N1 first decoding sub-regions and a second decoding strategy corresponding to each of the N2 second decoding sub-regions includes: when it is determined that an encoding strategy corresponding to each of the N1 first decoding sub-regions is a first encoding strategy according to a second predetermined association relationship set, determining that the decoding strategy corresponding to each of the N1 first decoding sub-regions is the first decoding strategy, where the second predetermined association relationship set includes N1 second predetermined association relationships, each of the second predetermined association relationships characterizes an association relationship between a first predetermined region identifier and a first predetermined strategy identifier, the first predetermined region identifier is configured to characterize the first decoding sub-region, and the first predetermined strategy identifier characterizes that the encoding strategy corresponding to the first decoding sub-region is the first encoding strategy; and when it is determined that an encoding strategy corresponding to each of the N2 second decoding sub-regions is a second encoding strategy according to a third predetermined association relationship set, determining that the decoding strategy corresponding to each of the N2 second decoding sub-regions is the second decoding strategy, where the third predetermined association relationship set includes N2 third predetermined association relationships, each of the third predetermined association relationship characterizes an association relationship between a second predetermined region identifier and a second predetermined strategy identifier, the second predetermined region identifier is configured to characterize the second decoding sub-region, and the second predetermined strategy identifier characterizes that the encoding strategy corresponding to the second decoding sub-region is the second encoding strategy.

For example, the decoding the second encoded information to obtain second to-be-encoded information corresponding to a display apparatus includes: obtaining a plurality of second check codes according to the second encoded information; determining a second to-be-encoded group corresponding to each of the plurality of second check codes, so as to obtain a plurality of second to-be-encoded groups; and obtaining the second to-be-encoded information according to the plurality of second to-be-encoded groups.

For example, the processing a to-be-processed image to obtain a second encoded image includes: obtaining a feature map of at least one scale according to the to-be-processed image; and obtaining the second encoded image according to the feature map of the at least one scale.

For example, the at least one scale includes J scales, where J is a positive integer; and the obtaining the second encoded image according to the feature map of the at least one scale includes: in a case of 1≤j<J, obtaining a fused feature map of a j^{th} scale according to the feature map of the j^{th} scale and an upsampled feature map of the j^{th} scale, where the upsampled feature map of the j^{th} scale is obtained according to the feature map of a (j+1)^{th} scale and an upsampled feature map of the (j+1)^{th} scale, and the feature map of the j^{th} scale is obtained according to the feature map of a (j−1)^{th} scale, where j is an integer greater than or equal to 1 and less than or equal to J; and obtaining the second encoded image according to a fused feature map of a 1^{st} scale

According to a third aspect, the present disclosure further provides an electronic device, including: one or more processors; and a memory configured to store one or more programs, where the one or more programs are configured to, when executed by the one or more processors, cause the one or more processors to implement the above-mentioned method of processing an image.

According to a fourth aspect, the present disclosure further provides a computer-readable storage medium having executable instructions stored thereon, where the instructions are configured to, when executed by a processor, cause the processor to implement the above-mentioned method of processing an image.

According to a fifth aspect, the present disclosure further provides a computer program product including a computer program, where the computer program is configured to, when executed by a processor, implement the above-mentioned method of processing an image.

### BRIEF DESCRIPTION OF THE DRAWINGS

The above and other features of embodiments of the present disclosure will become more apparent through the following detailed descriptions with reference to the accompanying drawings, in which:

FIG. 1 shows a flowchart of a method of processing an image according to an embodiment of the present disclosure;

FIG. 2A shows a schematic diagram of a first encoding sub-region under a first encoding strategy according to an embodiment of the present disclosure;

FIG. 2B shows a schematic diagram of a second encoding sub-region under a second encoding strategy according to an embodiment of the present disclosure;

FIG. 2C shows a schematic diagram of coexistence of a first encoding sub-region and a second encoding sub-region according to an embodiment of the present disclosure;

FIG. 2D shows a schematic diagram of coexistence of a first encoding sub-region and a second encoding sub-region according to another embodiment of the present disclosure;

FIG. 2E shows a schematic diagram of a plurality of first predetermined regions provided on a to-be-encoded image according to embodiments of the present disclosure;

FIG. 3 shows a schematic diagram of a first encoded image according to an embodiment of the present disclosure;

FIG. 4 shows a schematic diagram of a fused image according to an embodiment of the present disclosure;

FIG. 5 shows a flowchart of a method of processing an image according to another embodiment of the present disclosure;

FIG. 6 shows a flowchart of obtaining a second encoded image from a fused image according to an embodiment of the present disclosure;

FIG. 7 shows a framework diagram of a method of processing an image according to yet another embodiment of the present disclosure; and

FIG. 8 shows a block diagram of an electronic device suitable for implementing a method of processing an image according to an embodiment of the present disclosure.

In the accompanying drawings, the same or similar structures are marked with the same or similar reference numerals.

### DETAILED DESCRIPTION OF EMBODIMENTS

In order to make objectives, technical solutions and advantages of the present disclosure clearer, the technical solutions of embodiments of the present disclosure will be described clearly and completely in combination with accompanying drawings in embodiments of the present disclosure. Obviously, the described embodiments are some, but not all of embodiments of the present disclosure. Based on the described embodiments of the present disclosure, all other embodiments obtained by those skilled in the art without any creative work fall within the scope of protection of the present disclosure. It should be noted that throughout the accompanying drawings, the same elements are indicated by the same or similar reference numerals. In the following descriptions, some specific embodiments are only used for the purpose of description, and should not be construed as limiting the present disclosure, but as examples of embodiments of the present disclosure. When it may cause confusion in the understanding of the present disclosure, conventional structures or configurations may be omitted. It should be noted that the shapes and dimensions of components in the accompanying drawings do not necessarily reflect actual sizes and/or ratios, but merely illustrate the content of embodiments of the present disclosure.

It should be noted that, in the accompanying drawings, a size and a relative size of an element may be enlarged for the purpose of clarity and/or description. Therefore, the sizes and relative sizes of various elements are not necessarily limited to the sizes and relative sizes shown in the accompanying drawings. In the specification and the accompanying drawings, the same or similar reference numerals indicate the same or similar components.

Unless otherwise defined, technical or scientific terms used in the present disclosure shall have ordinary meanings as understood by those skilled in the art to which the present disclosure belongs. Terms “first”, “second”, etc. used in the present disclosure do not denote any order, quantity, or importance, but are merely used to distinguish different components. A word “including” or “comprising”, etc. means that elements or objects before the word include elements or objects listed after the word and their equivalents, but do not exclude other elements or objects.

Unless otherwise specifically stated, directional terms such as “upper”, “lower”, “left”, “right”, “inner”, “outer”, etc. used herein are used to indicate the orientation or positional relationships shown in the accompanying drawings, and are only for the convenience of describing the present disclosure, and do not indicate or imply that the apparatus, element or component referred to must have a specific orientation, and be constructed or operate in the specific orientation. It should be understood that when absolute positions of the described objects changes, the relative positional relationships they represent may also change accordingly. Therefore, these directional terms should not be construed as limiting the present disclosure.

In addition, in the descriptions of embodiments of the present disclosure, a term “connected” or “connected to” may refer to a direct connection between two components, or may refer to a connection between two components via one or more other components. In addition, the two components may be connected or coupled by a wired or wireless method.

In the technical solutions of the present disclosure, the collection, storage, use, processing, transmission, provision, disclosure, application, etc. of the data involved (including but not limited to user personal information) comply with the provisions of relevant laws and regulations, take necessary confidentiality measures, and do not violate public order and good custom.

Screen watermarking technology has a long history, and a screen watermark is generally divided into a light watermark and a dark watermark. Although an addition of a light watermark or a shade watermark to screen information may reduce a risk of screen display information being leaked, since the light watermark is a watermark visible to the naked eye, it may cause a poor viewing experience for a user and affect a display effect of the screen information. Moreover, a display of device information by the light watermark may also result in a secondary information leakage. Although the dark watermark may be displayed imperceptibly, it may only encrypt digital data and may not provide a basis for traceability of behaviors in the processes such as screenshots, candid photography, etc.

In view of this, the present disclosure provides a method of processing an image, which is used to prevent information leakage, improve information security, and improve user experience, and may also provide a basis for accurate traceability of behaviors such as screenshots, candid photography, etc. Specifically, the method includes encoding a first to-be-encoded information corresponding to a display apparatus, so as to obtain a first encoded information; adjusting a pixel value of at least one first predetermined region of a to-be-encoded image corresponding to a target image according to the first encoded information, so as to obtain a first encoded image; and fusing the target image with the first encoded image to obtain a fused image.

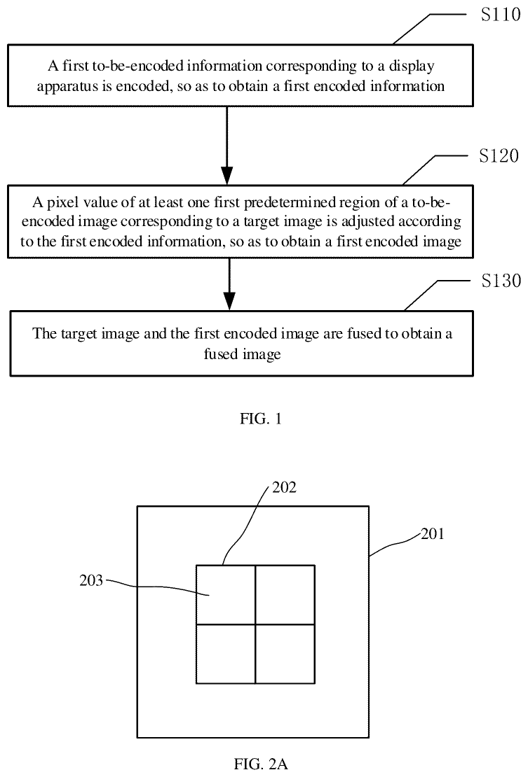

FIG. 1 shows a flowchart of a method of processing an image according to an embodiment of the present disclosure.

As shown in FIG. 1, the method of processing an image may include operations S110 to S130.

In operation S110, a first to-be-encoded information corresponding to a display apparatus is encoded, so as to obtain first encoded information.

In operation S120, a pixel value of at least one first predetermined region of a to-be-encoded image corresponding to a target image is adjusted according to the first encoded information, so as to obtain a first encoded image.

In operation S130, the target image and the first encoded image are fused to obtain a fused image.

According to embodiments of the present disclosure, the display apparatus may be an apparatus with a display screen, such as a mobile phone, a tablet computer, a television, a monitor, a laptop computer, a digital photo frame, a navigator, or any other product or component with a display function.

According to embodiments of the present disclosure, the first to-be-encoded information corresponding to the display apparatus may refer to at least one of a device identifier of the display apparatus, a time displayed on the display apparatus or a geographical location. The device identifier may be a device's SN (Serial Number) code, a device's IP (Internet Protocol Address) address or MAC (Media Access Control Address) address, or a device's internal number, etc. The time displayed on the display apparatus may be a time including year, month, day, hour and minute. The geographic location may be a geographic location where the device is currently located.

According to embodiments of the present disclosure, the first encoded information may be information obtained by a multi-system conversion on the to-be-encoded information. Conversion of number systems may be understood as a binary conversion, a quaternary conversion, an octal conversion, a decimal conversion, a hexadecimal conversion, etc. For example, the first encoded information may be information obtained by performing the binary conversion on at least one of the device identifier, the time displayed on the display apparatus or the geographical location.

According to embodiments of the present disclosure, by adding the information such as the encoded device identifier, displayed time, geographical location, etc. to the target image, a basis may be provided for traceability analysis of the target image when the target image is subsequently leaked.

According to embodiments of the present disclosure, the target image may be an image to be displayed on a display screen, which may refer to a picture with a visual effect.

According to embodiments of the present disclosure, the to-be-encoded image may be an image matrix used to generate an encoded image. Specifically, a size of the to-be-encoded image is the same as a size of the target image. That is, a width and a height of the to-be-encoded image are the same as a width and a height of the target image. Before forming the encoded image, pixel values on the to-be-encoded image may all be 0.

According to embodiments of the present disclosure, the first predetermined region may be an encoding region on the to-be-encoded image, and a first encoded image corresponding to an adjusted pixel value of the encoding region may be obtained by changing a pixel value of the encoding region according to the first encoded information. The pixel value on the first encoded image may be associated with the information such as the encoded device identifier, displayed time, geographical location, etc.

According to embodiments of the present disclosure, the first encoded image with the device identifier, the displayed time, and the geographic location is superimposed and fused with a target image to be displayed on a display screen, and a transparency of the first encoded image is adjusted to a preset transparency value, so that the first encoded image may be tracelessly displayed on the display screen.

According to embodiments of the present disclosure, the first to-be-encoded information corresponding to the display apparatus is encoded onto the to-be-encoded image, so as to obtain the first encoded image, and the target image and the first encoded image are fused, so as to achieve a traceless display of the first encoded image. Compared with the light watermark in the prior art, embodiments of the present disclosure may achieve a traceless display of the first encoded image, thereby improving the user's viewing experience. In addition, the light watermark in the prior art generally directly displays the first to-be-encoded information in embodiments of the present disclosure. In the present disclosure, after the first to-be-encoded information is encoded to obtain the encoded information, the first encoded image obtained according to the encoded information is tracelessly displayed on the display screen. Embodiments of the present disclosure avoid a problem of a secondary leakage of the first to-be-encoded information and improve a security of the information. Compared with the dark watermark in the prior art, objects targeted by embodiments of the present disclosure may include images, not just digital data, thereby improving a universality of screen watermarking technology. Furthermore, the first encoded image of embodiments of the present disclosure is also convenient for extraction in a subsequent decoding process, and the first to-be-encoded information is obtained, thereby providing a convenience and basis for accurate traceability of the information.

According to embodiments of the present disclosure, operation $110 may include; dividing a multi-bit first to-be-encoded code into a plurality of first to-be-encoded groups; determining a first check code corresponding to each of the plurality of first to-be-encoded groups, so as to obtain a plurality of first check codes; and obtaining the first encoded information according to the multi-bit first to-be-encoded code and the plurality of first check codes.

According to embodiments of the present disclosure, the first to-be-encoded information may include a multi-bit first to-be-encoded code, such as a to-be-encoded code composed of the SN code of the device and the time displayed on the display apparatus.

According to embodiments of the present disclosure, the determining a first check code corresponding to each of the plurality of first to-be-encoded groups so as to obtain a plurality of first check codes may include; determining a polynomial and a fundamental domain related to the first to-be-encoded code; dividing the first to-be-encoded code into groups by predetermined bits, so as to obtain a plurality of first to-be-encoded groups; determining the first to-be-encoded group obtained by the division as a coefficient of the polynomial to construct a new polynomial, and calculating a remainder of the new polynomial divided by the original polynomial, and determining the remainder as the first check code. A final plurality of first encoding codes may be obtained by adding the remainder to the end of the first to-be-encoded code.

According to embodiments of the present disclosure, the above-mentioned encoding operation may be understood as BCH encoding. That is, the first to-be-encoded code is divided into first to-be-encoded groups by fixed k (k is a positive integer) bits, and then each first to-be-encoded group is independently transformed into a binary digital group with a length of n (n>k). The process may be called a codeword. If the number of the first to-be-encoded groups is M (obviously M>=2), the whole of M codewords thus obtained is called the first to-be-encoded group with a code length of n and information number of M, which is denoted by n, M. The process of transforming the first to-be-encoded group into the codewords is called encoding, and an inverse process thereof is called decoding.

According to embodiments of the present disclosure, by using a BCH encoding method, since the BCH encoding already includes a check bit, it may be used to detect and repair an error of data, which may play a better check role in data transmission and verification scenarios. An accuracy of information restoration when the encoded information is restored may also be improved by using the BCH encoding method.

According to embodiments of the present disclosure, the first encoded information may include a first encoding code of at least one bit. Operation S120 may further include; adjusting the pixel value of the at least one first predetermined region of the to-be-encoded image according to at least one first predetermined pixel value, so as to obtain the first encoded image, wherein at least one first predetermined region of the first encoded image comprises the at least one first predetermined pixel value, and the at least one first predetermined pixel value corresponds to the at least one bit of the first encoding code respectively.

According to embodiments of the present disclosure, the first encoding code may be a N-bit code, where N is a positive integer. Taking the first to-be-encoded information including the device identifier and the displayed time as an example, the first encoded information may include a 24-bit binary encoding code about the device identifier and a 23-bit binary encoding code about the time. Therefore, the first encoded information may include a 47-bit encoding code, and N is 47 at this time. It should be noted that the above-mentioned specific number of bits is only for example, and the number of bits may be adaptively adjusted according to actual needs.

According to embodiments of the present disclosure, since the first encoded information needs to be presented in a form of an image, it is required to establish a corresponding relationship between the first encoded information and the pixel value. Specifically, it is required to establish a corresponding relationship between the encoding code and the pixel value in the first encoded information. For example, one or more pixel values may be pre-configured to be associated with the encoding code, and the first predetermined pixel value may be the pre-configured pixel value. For example, the encoding code is 0, and the corresponding first predetermined pixel value may be 0 or 255, 0, 0, 0. When adjusting the pixel value of the first predetermined region on the to-be-encoded image according to the first encoded information, an original pixel value of the first predetermined region may be adjusted to the above-mentioned first predetermined pixel value.

According to embodiments of the present disclosure, the adjusting the pixel value of the at least one first predetermined region of the to-be-encoded image according to at least one first predetermined pixel value so as to obtain the first encoded image may include; for each first predetermined region in the at least one first predetermined region, dividing the first predetermined region into N first predetermined sub-regions, where the N first predetermined sub-regions include N1 first encoding sub-regions and N2 second encoding sub-regions, the N-bit first encoding code includes a N1-bit first encoding code and a N2-bit second encoding code, where N1 and N2 are natural numbers; each bit of the N1-bit first encoding code corresponds to one first predetermined pixel value, and each bit of the N2-bit second encoding code corresponds to more than one first predetermined pixel values; adjusting, based on a first encoding strategy, pixel values of the N1 first encoding sub-regions of the to-be-encoded image according to the first predetermined pixel value corresponding to each bit of the N1-bit first encoding code, so as to obtain N1 first encoding region images; adjusting, based on a second encoding strategy, pixel values of the N2 second encoding sub-regions of the to-be-encoded image according to the first predetermined pixel values corresponding to each bit of the N2-bit second encoding code, so as to obtain N2 second encoding region images; and obtaining the first encoded image according to the N1 first encoding region images and the N2 second encoding region images.

According to embodiments of the present disclosure, the first encoding sub-region may be a region for implementing the first encoding strategy; and the second encoding sub-region may be a region for implementing the second encoding strategy. In the first predetermined region, the first encoding sub-region and the second encoding sub-region may exist at the same time, or only the first encoding sub-region or only the second encoding sub-region may exist, which may be adaptively adjusted according to actual needs. Positions of the first encoding sub-region and the second encoding sub-region may be adaptively adjusted according to actual needs.

According to embodiments of the present disclosure, the first encoding code may refer to an encoding code using the first encoding strategy; and the second encoding code may refer to an encoding code using the second encoding strategy. Each first encoding code in the first encoding strategy corresponds to a first predetermined pixel value; each second encoding code in the second encoding strategy may correspond to a plurality of first predetermined pixel values.

For example, assuming that the first encoding code is a 47-bit code, the first predetermined region may be divided into 47 first predetermined sub-regions. In the 47-bit first encoding code, the 24-bit encoding code representing the device may be the first encoding code, which is processed using the first encoding strategy. At this time, 24 first encoding sub-regions may be provided; the 23-bit encoding code representing the time may be the second encoding code, which is processed using the second encoding strategy. At this time, 23 second encoding sub-regions may be provided. Optionally, the 47-bit first encoding code may also be processed using only the first encoding strategy or only the second encoding strategy. In a case that only the first encoding strategy is used, the number N1 of the first encoding sub-regions is 47, and the number N2 of the second encoding sub-regions is 0. In a case that only the second encoding strategy is used, the number N1 of the first encoding sub-regions is 0, and the number N2 of the second encoding sub-regions is 47. In another embodiment, the 24-bit encoding code representing the device identifier may also be processed by a combination of the first encoding strategy and the second encoding strategy, and the 23-bit encoding code representing the time may also be processed by a combination of the first encoding strategy and the second encoding strategy. The specific strategy used may be adaptively adjusted according to actual needs.

According to embodiments of the present disclosure, the first encoding region image may be obtained by adjusting a pixel value of the first encoding sub-region; and the second encoding region image may be obtained by adjusting a pixel value of the second encoding sub- region.

According to embodiments of the present disclosure, the adjusting, based on a first encoding strategy, pixel values of the N1 first encoding sub-regions of the to-be-encoded image according to a first predetermined pixel value corresponding to the N1-bit first encoding code, so as to obtain N1 first encoding region images includes: for each of the N1 first encoding sub-regions, determining a first encoding code corresponding to the first encoding sub-region, so as to obtain a first target encoding code corresponding to the first encoding sub-region; and adjusting the pixel value of the first encoding sub-region to a first predetermined pixel value corresponding to the first target encoding code, so as to obtain the first encoding region image corresponding to the first encoding sub-region.

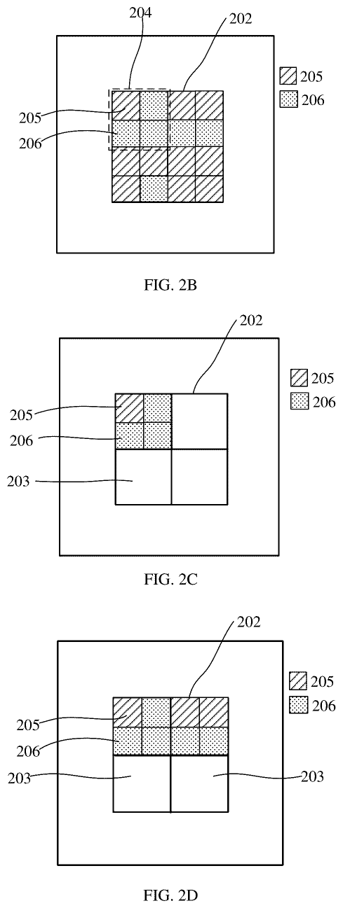

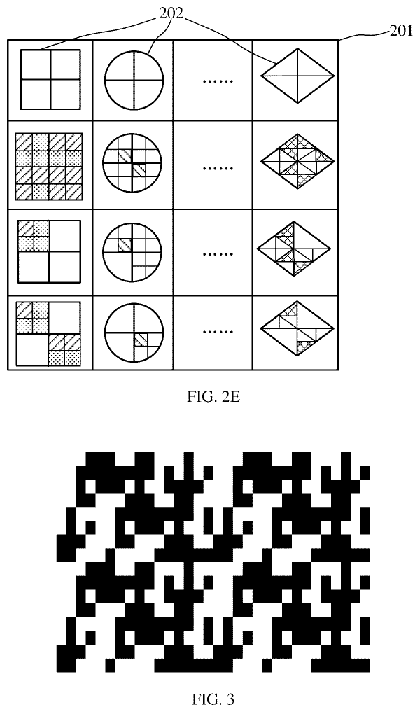

FIG. 2A shows a schematic diagram of a first encoding sub-region under a first encoding strategy according to an embodiment of the present disclosure.

In a case shown in FIG. 2A, N1 may be 4. Specifically, an encodable region may be selected in the to-be-encoded image 201 as a first predetermined region 202, and the first predetermined region 202 may be divided into four first encoding sub-regions 203. Each first encoding sub-region 203 may represent one bit of the first encoding code. Taking a quaternary system as an example, the first encoding code represented by each first encoding sub-region 203 has four options of 0, 1, 2, and 3. The first target encoding code corresponding to the first encoding sub-region 203 may be one of 0, 1, 2 or 3. In embodiments of the present disclosure, a pixel value size is used to represent the first encoding code. In a case of an 8-bit color depth screen display, the minimum pixel value displayed on the screen is 0 and the maximum pixel value displayed on the screen is 255. In a case of using a quaternary system, pixel values of a first encoding sub-region all being 0 indicates that the first encoding code is 0, the pixel values all being 85 indicates that the first encoding code is 1, the pixel values all being 170 indicates that the first encoding code is 2, and the pixel values all being 255 indicates that the first encoding code is 3.

For example, in FIG. 2A, if the pixel values of the first encoding sub-region from left to right in a first row are 0 and 85 respectively, and the pixel values of the first encoding sub-region from left to right in the second row are 170 and 255 respectively, the encoding codes represented by the first predetermined region are 0, 1, 2, and 3 respectively. It may be understood that, in an actual process of adjusting pixel values, the pixel values may be adjusted in an order from left to right and then from top to bottom, or from top to bottom and then from left to right, or from right to left and then from bottom to top, or from bottom to top and then from right to left, or clockwise, or counterclockwise or like. The specific adjustment order may be adaptively adjusted according to actual needs.

According to embodiments of the present disclosure, the first predetermined region may be divided into the first encoding sub-regions by a method of horizontal or vertical division as shown in FIG. 2A, or by a method of diagonal division. The division method may be adaptively adjusted according to actual needs.

According to embodiments of the present disclosure, a shape of the first predetermined region may be a square as shown in FIG. 2A. In addition, the shape of the first predetermined region may also be at least one of a rectangle, an irregular trapezoid, a trapezoid, a parallelogram, a rhombus, a triangle or a circle.

According to embodiments of the present disclosure, the shape of the first encoding sub-region may be a square as shown in FIG. 2A. In addition, the shape of the first predetermined region may also be at least one of a rectangle, an irregular trapezoid, a trapezoid, a parallelogram, a rhombus, a triangle or a circle.

According to embodiments of the present disclosure, the adjusting, based on a second encoding strategy, pixel values of the N2 second encoding sub-regions of the to-be-encoded image according to the first predetermined pixel values corresponding to the N2-bit second encoding code so as to obtain N2 second encoding region images includes: for each second encoding sub-region in the N2 second encoding sub-regions, determining a second encoding code corresponding to the second encoding sub-region, so as to obtain a second target encoding code corresponding to the second encoding sub-region; determining a first predetermined ratio corresponding to the second target encoding code according to a first predetermined association relationship set, where the first predetermined association relationship set includes N2 first predetermined association relationships, and each of the first predetermined association relationships characterizes an association relationship between the second encoding code and the first predetermined ratio; and adjusting a pixel value of a first encoding region in the second encoding sub-region to the first predetermined encoding pixel value, and adjusting a pixel value of a second encoding region in the second encoding sub-region to the at least one second predetermined encoding pixel value according to the first predetermined ratio, so as to obtain the second encoding region image corresponding to the second encoding sub-region, where a ratio between size information of the first encoding region and size information of the second encoding sub-region is the first predetermined ratio.

According to embodiment of the present disclosure, the plurality of first predetermined pixel values may include a first predetermined encoding pixel value and at least one second predetermined encoding pixel value, and the first predetermined encoding pixel value is greater than any one of the at least one second predetermined encoding pixel value. For example, the encoding code is 0, which may correspond to four pixel values of 255, 0, 0, and 0. The first predetermined encoding pixel value may be 255, and the second predetermined encoding pixel value may be any of the other pixel values among the four pixel values except 255.

FIG. 2B shows a schematic diagram of a second encoding sub-region under a second encoding strategy according to an embodiment of the present disclosure.

In a case shown in FIG. 2B, N2 may be 4. Specifically, the first predetermined region 202 may be divided into four second encoding sub-regions 204. Each second encoding sub-region 204 may represent one bit of second encoding code. Taking a quaternary system as an example, the second encoding code represented by each second encoding sub-region 204 has four options of 0, 1, 2, and 3. The second target encoding code corresponding to the second encoding sub-region 204 may be one of 0, 1, 2 or 3.

In the case shown in FIG. 2B, the first predetermined association relationship set may include four first predetermined association relationships, that is, four association relationships between the second encoding code and the first predetermined ratio.

Continuing to refer to 2B, each second encoding sub-region 204 may also be evenly divided into a first encoding region 205 and a second encoding region 206. A pixel value of the first encoding region is the first predetermined encoding pixel value, a pixel value of the second encoding region is the second predetermined encoding pixel value, and the first predetermined encoding pixel value is greater than the second predetermined encoding pixel value.

According to embodiments of the present disclosure, the first predetermined ratio may be a ratio between size information of the first encoding region and size information of the second encoding sub-region. The size information may refer to the number of regions or an area of the region.

Continuing to refer to FIG. 2B, for example, taking a division of the second encoding sub-region 204 into four equal parts as an example, if the second encoding code is 0, a corresponding first predetermined ratio is 1/4. That is, an area of the first encoding region 205 accounts for ¼ of a total area of the second encoding sub-region. At this time, only one first encoding region 205 and three second encoding regions 206 may be provided in the second encoding sub-region 204. The first predetermined pixel value of the first encoding region 205 may be 255, and the pixel values of the remaining three second encoding regions 206 may be 0, 0, and 0, respectively.

If the second encoding code is 1, the corresponding first predetermined ratio is 2/4. That is, the area of the first encoded region 205 accounts for 2/4 of the total area of the second encoded sub-region. At this time, two first encoded regions 205 and two second encoded regions 206 may be provided in the second encoded sub-region 204. The first predetermined pixel values of the two first encoded regions 205 may all be 255, and the pixel values of the remaining two second encoded regions 206 may be 0 and 0 respectively.

If the second encoding code is 2, the corresponding first predetermined ratio is 3/4. That is, the area of the first encoded region 205 accounts for ¾ of the total area of the second encoded sub-region. At this time, three first encoding regions 205 and one second encoding region 206 may be provided in the second encoded sub-region 204. The first predetermined pixel values of the three first encoding regions 205 may all be 255, and the pixel value of the remaining one second encoding region 206 may be 0.

If the second encoding code is 3, the corresponding first predetermined ratio is 4/4. That is, the area of the first encoding region 205 accounts for 4/4 of the total area of the second encoding sub-region. At this time, four first encoding regions 205 and zero second encoding region 206 may be provided in the second encoding sub-region 204. The first predetermined pixel values of the four first encoding regions 205 may all be 255.

It may be understood that, in the actual process of adjusting pixel values, the pixel values may be adjusted in an order from left to right and then from top to bottom, or from top to bottom and then from left to right, or from right to left and then from bottom to top, or from bottom to top and then from right to left, or clockwise, or counterclockwise, or the like. The specific adjustment order may be adaptively adjusted according to actual needs.

According to embodiments of the present disclosure, the first predetermined region may be divided into the second encoding sub-regions by a method of horizontal or vertical division as shown in FIG. 2B, or by a method diagonal division. The division method may be adaptively adjusted according to actual needs.

According to embodiments of the present disclosure, the second encoding sub-region may be divided into the first encoding region and the second encoding region by a method of horizontal or vertical division as shown in FIG. 2B, or by a method diagonal division. The division method may be adaptively adjusted according to actual needs.

According to embodiments of the present disclosure, a shape of the second encoding sub-region may be a square as shown in FIG. 2B. In addition, the shape of the second encoding sub-region may be at least one of a rectangle, an irregular trapezoid, a trapezoid, a parallelogram, a rhombus, a triangle or a circle.

According to embodiments of the present disclosure, the shape of the first encoding region and the shape of the second encoding region may both be a square as shown in FIG. 2B. In addition, the shape of the first encoding region and the shape of the second encoding region may both also be at least one of a rectangle, an irregular trapezoid, a trapezoid, a parallelogram, a rhombus, a triangle or a circle.

FIG. 2C shows a schematic diagram of coexistence of a first encoding sub-region and a second encoding sub-region according to an embodiment of the present disclosure.

As shown in FIG. 2C, the first predetermined region 202 may include one second encoding sub-region and three first encoding sub-regions. In the one second encoding sub-region, one first encoding region and three second encoding regions may be provided.

FIG. 2D shows a schematic diagram of coexistence of a first encoding sub-region and a second encoding sub-region according to another embodiment of the present disclosure.

As shown in FIG. 2D, the first predetermined region 202 may further include two second encoding sub-regions and two first encoding sub-regions. In one of the second encoding sub-regions, one first encoding region and three second encoding regions may be provided; in the other second encoding sub-region, two first encoding regions and two second encoding regions may be provided.

Continuing to refer to FIG. 2C to FIG. 2D, an arrangement and combination method of the first encoding sub-regions 203 and the second encoding sub-regions 204 may be adaptively adjusted according to actual needs, and an arrangement and combination method of the first encoding regions 205 and the second encoding regions 206 in the second encoding sub-region 204 may also be adaptively adjusted according to actual needs.

FIG. 2E shows a schematic diagram of a plurality of first predetermined regions provided on a to-be-encoded image according to embodiments of the present disclosure.

As shown in FIG. 2E, a plurality of first predetermined regions 202 may be selected on the to-be-encoded image 201 for encoding. Each first predetermined region 202 may use the same or different encoding strategies, and each first predetermined region 202 may use the same or different shapes to achieve encoding.

In another embodiment, the plurality of first predetermined regions 202 may be selected near an edge around the to-be-encoded image 201 and near a center of the image, so as to prevent a problem of an incomplete encoded image due to edge cropping during a subsequent decoding process.

According to embodiments of the present disclosure, in order to ensure an accuracy in a process of restoring the encoded image, the encoding should not be too complex. Too complex encoding may have a high bit error rate during the restoration. In order to further improve an accuracy of restoration, embodiment of the present disclosure encode information by using the above-mentioned redundant encoding method, so as to accurately extract complete information during the restoration process. By encoding the plurality of first predetermined regions 202 in the to-be-encoded image 201 as described above, a replication of the encoded image may be achieved, so that a final fused image may have a plurality of encoded images. When restoring the fused image, the encoded images of different first predetermined regions may be effectively complementary to each other, thereby completely restoring accurate information. The complementary method may be selected from overlapping encoding regions, modes of encoding values, etc.

According to embodiments of the present disclosure, the presentation of the device identifier, the time displayed on the display apparatus, and the geographical location in a form of pixel values on the final fused image may not only achieving an encryption processing on the information, but also provide a basis for accurate traceability of the information. For example, if the fused image is captured and disseminated without permission, after the disseminated fused image is discovered, by performing an information restoration processing on the first encoded image on the fused image, what time the fused image was captured at, which device the fused image came from, and the geographical location of the fused image at the time when the fused image was captured may be known. Based on this, the presentation of the device identifier, the time displayed on the display apparatus, and the geographical location in the form of pixel values on the final fused image may provide a basis for the accurate traceability of the information.

According to embodiments of the present disclosure, the above-mentioned method of processing an image may further include; determining a second predetermined association relationship corresponding to each of the N1 first encoding sub-regions, so as to obtain a second predetermined association relationship set, where the second predetermined association relationship set includes N1 second predetermined association relationships, each of the second predetermined association relationships characterizes an association relationship between a first predetermined region identifier and a first predetermined strategy identifier, the first predetermined region identifier is used to characterize the first encoding sub-region, and the first predetermined strategy identifier characterizes that an encoding strategy corresponding to the first encoding sub-region is the first encoding strategy; determining a third predetermined association relationship corresponding to each of the N2 second encoding sub-regions, so as to obtain a third predetermined association relationship set, where the third predetermined association relationship set includes N2 third predetermined association relationships, each of the third predetermined association relationship characterizes an association relationship between a second predetermined region identifier and a second predetermined strategy identifier, the second predetermined region identifier is used to characterize the second encoding sub-region, and the second predetermined strategy identifier characterizes that an encoding strategy corresponding to the second encoding sub-region is the second encoding strategy; and storing the second predetermined association relationship set and the third predetermined association relationship set.

According to embodiments of the present disclosure, by constructing a relationship between a first predetermined region identifier and a first predetermined strategy identifier and constructing a relationship between a second predetermined region identifier and a second predetermined strategy identifier, when restoring the encoded information, information of a corresponding predetermined sub-region may be directly restored using a corresponding decoding strategy according to an identifier and a corresponding decoding strategy. For example, after the first encoding sub-region is encoded using the first encoding strategy, the second predetermined association relationship set may be obtained by storing the first predetermined strategy identifier representing the first encoding strategy and the first predetermined region identifier representing the first encoding sub-region in a specified list. In a subsequent process of information restoration in the region, the first predetermined strategy identifier for which information restoration is required and the first predetermined region identifier for which information restoration is required may be found from the second predetermined association relationship set, and the first encoding strategy may be obtained according to the first predetermined strategy identifier, and then an information restoration operation may be performed on information of the first encoding sub-region by using a decoding strategy related to the first encoding strategy.

According to embodiments of the present disclosure, in addition to using an identifier to mark the used encoding strategy and the first predetermined sub-region, the encoding strategy and the first predetermined sub-region may also be distinguished by using a shape of the encoding region. For example, a shape of the first encoding sub-region using the first encoding strategy may be set to a quadrilateral, and a shape of the second encoding sub-region using the second encoding strategy may be set to a triangle. In this way, when restoring information on the first encoded image, the encoding strategy used by the first predetermined sub-region may be determined according to a shape of the first predetermined sub-region, and then a restoration of information of the first predetermined sub-region may be achieved by using the decoding strategy corresponding to the encoding strategy.

According to embodiments of the present disclosure, by constructing a second association relationship set and a third association relationship set, or distinguishing the first encoding strategy from the second encoding strategy using the shape of the first predetermined sub-region, the encoding strategy used by the first encoded image and the first predetermined sub-region using the encoding strategy may be quickly distinguished during the process of restoring the information on the first encoded image, so that a corresponding decoding strategy may be found to restore the information, so as to improve an efficiency of information restoration of the first encoded image.

According to embodiments of the present disclosure, operation S130 may further include; determining a product between a pixel value each of at least one pixel included in the target image and a first predetermined coefficient, so as to obtain a first pixel information; determining a product between a pixel value each of at least one pixel included in the first encoded image and a second predetermined coefficient, so as to obtain a second pixel information; obtaining a third pixel information according to the first pixel information and the second pixel information; and obtaining the fused image according to the third pixel information.

In order to display the first encoded image tracelessly on the target image, the first predetermined coefficient and the second predetermined coefficient may be provided when the first encoded image and the target image are fused, and the third pixel information of the fused image may be determined by a product of each pixel and each predetermined coefficient. By adjusting the first predetermined coefficient and the second predetermined coefficient, the first encoded image may be tracelessly displayed on the target image, and is also convenient for extraction in the subsequent decoding process. Specifically, the process of determining a third pixel may be shown in Equation (1).

$$p = a \times b + c \times d \qquad ( 1 )$$

In the equation, p may represent the third pixel information, for example, the third pixel value (a pixel value of at least one pixel of the fused image), a may represent the pixel value of the at least one pixel included in the target image, b may represent the first predetermined coefficient; c may represent the pixel value of the at least one pixel included in the first encoded image, and d may represent the second predetermined coefficient.

According to embodiments of the present disclosure, when the target image and the first encoded image are fused, a transparency of the first encoded image may also be set. For example, the transparency of the first encoded image may be set to 97% and then superimposed on the target image. The superposition may not affect a display effect and may be imperceptible to use.

According to embodiments of the present disclosure, in order to allow the first encoded image to be displayed tracelessly on the target image, a RGB pixel channel on the first encoded image may also be adjusted. For example, a color displayed by the first encoded image is adjusted to a yellow-green color that is difficult to be distinguished by naked eyes, and then the first encoded image with the adjusted color is fused with the target image according to the process shown in Equation (1), so as to obtain the fused image. By adjusting the first encoded image to a color that is difficult to be distinguished by the naked eyes, the first encoded image may be tracelessly displayed on the target image and may also be convenient for extraction.

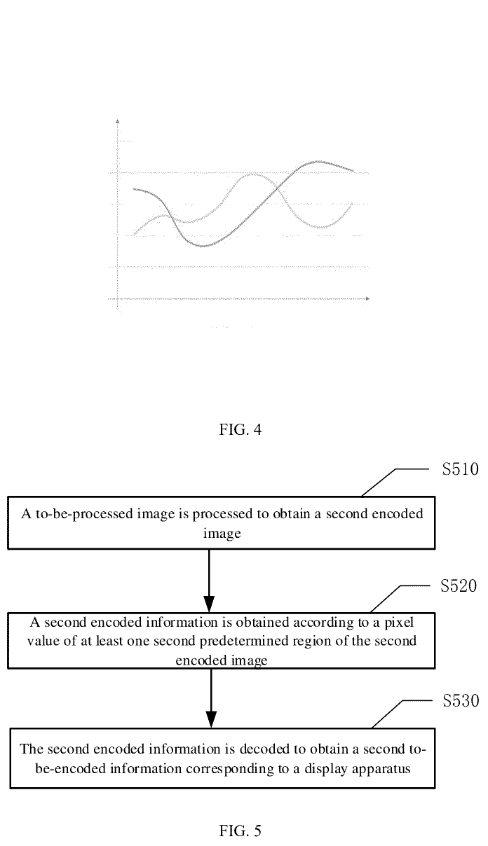

FIG. 3 shows a schematic diagram of a first encoded image according to an embodiment of the present disclosure; FIG. 4 shows a schematic diagram of a fused image according to an embodiment of the present disclosure.

Referring to FIG. 3 and FIG. 4, FIG. 3 may be a first encoded image including the device identifier and the time displayed on the display apparatus, which is a two-dimensional image. The fused image as shown in FIG. 4 may be obtained by superimposing the first encoded image on the target image with a curve with a certain transparency.

FIG. 5 shows a flowchart of a method of processing an image according to another embodiment of the present disclosure.

As shown in FIG. 5, the method of processing an image according to another embodiment may include operations S510 to S530.

In operation S510, a to-be-processed image is processed to obtain a second encoded image, where the to-be-processed image includes one of: a fused image or a captured image corresponding to the fused image, and the fused image is obtained by the method of processing an image described in operations S110 to S130.

In operation S520, second encoded information is obtained according to a pixel value of at least one second predetermined region of the second encoded image.

In operation S530, the second encoded information is decoded to obtain second to-be-encoded information corresponding to a display apparatus.

According to embodiments of the present disclosure, the processing the to-be-processed image may be understood as performing a decoding operation on the to-be-processed image.

According to embodiments of the present disclosure, in a few scenarios, the fused image may be captured and disseminated without permission, or exported and disseminated as a file, resulting in an information leakage. The captured image corresponding to the fused image may refer to an image including the fused image captured without permission.

According to embodiments of the present disclosure, the second encoded image may refer to a decoded image obtained by decoding the to-be-processed image. The second encoded image may be the same as the first encoded image. The “first” and “second” are only used to distinguish between an image obtained in the encoding process and an image obtained in the decoding process. The second encoded image may also be associated with the information such as the encoded device identifier, time displayed on the display apparatus, geographical location information, etc.

According to embodiments of the present disclosure, the second predetermined region may refer to an encoding region on the second encoded image.

According to embodiments of the present disclosure, the second encoded information may refer to a device identifier, a time displayed on the display apparatus, a geographical location, etc. after the multi-system conversion. The multi-system conversion may include a binary conversion, a quaternary conversion, an octal conversion, a decimal conversion, a hexadecimal conversion, etc. The second to-be-encoded information may be the same as the first to-be-encoded information. The “first” and “second” are only used to distinguish between encoded information obtained by encoding and encoded information obtained in the decoding process.

According to embodiments of the present disclosure, the second to-be-encoded information may be the same as the first to-be-encoded information, including the information such as a device identifier, a time displayed on the display apparatus, a geographical location, etc. The “first” and “second” are only used to distinguish between to-be-encoded information that is required in the encoding process and to-be-encoded information obtained in the decoding process.

According to embodiments of the present disclosure, by decrypting the fused image

or the captured image corresponding to the fused image, what time the fused image was captured or exported at, which device the fused image came from, and the geographical location of the fused image at the time when the fused image was captured or exported may be obtained. Based on this, a basis may be provided for the accurate traceability of the information.

According to embodiments of the present disclosure, operation S510 may include; obtaining a feature map of at least one scale according to the to-be-processed image; and obtaining a second encoded image according to the feature map of the at least one scale.

According to embodiments of the present disclosure, the at least one scale includes J scales, where J is a positive integer; the obtaining the second encoded image according to the feature map of the at least one scale includes: in a case of 1≤j<J, obtaining a fused feature map of a j^{th} scale according to the feature map of the j^{th} scale and an upsampled feature map of the j^{th} scale, where the upsampled feature map of the j^{th} scale is obtained according to the feature map of a (j+1)^{th} scale and an upsampled feature map of the (j+1)^{th} scale, and the feature map of the j^{th} scale is obtained according to the feature map of a (j−1)^{th} scale, where j is an integer greater than or equal to 1 and less than or equal to J; and obtaining the second encoded image according to a fused feature map of a 1^{st} scale.

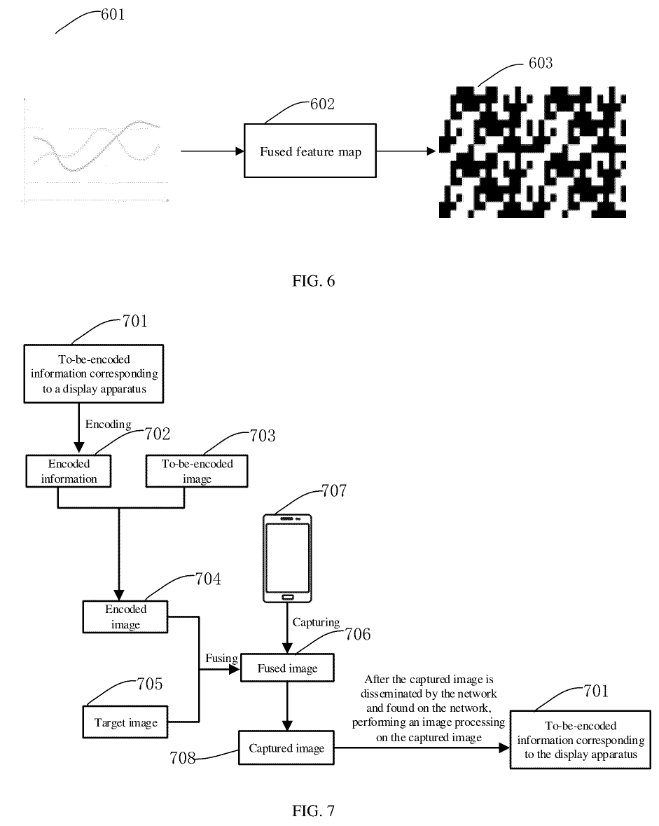

FIG. 6 shows a flowchart of obtaining a second encoded image from a fused image according to an embodiment of the present disclosure.

As shown in FIG. 6, the process of obtaining a second encoded image 603 from a fused image 601 may be implemented using an end-to-end deep learning image segmentation network, for example, by combining a U-Net model structure or a D-LinkNet model structure, etc. A fused feature map 602 may be obtained by combining the U-Net model structure or the D-LinkNet model structure.

According to embodiments of the present disclosure, some preprocessing, such as cropping, affine transformation, etc. may be performed on the captured image corresponding to the fused image before the captured image is input into the U-Net model or the D-LinkNet model, so as to convert the captured image into an image with the same resolution as the fused image.

According to embodiments of the present disclosure, the device identifier and the time displayed on the display apparatus may be decoded by decoding a second target image output by the U-Net model or the D-LinkNet model using a decoding strategy corresponding to the encoding strategy.

According to embodiments of the present disclosure, during model training of the U-Net model structure or the D-LinkNet model, a self-supervised learning method may be used to generate a random code map in real time and superimpose it with a training image during training. The code map may be used as a label of the network for training.

According to embodiments of the present disclosure, during a decoding stage, information of the output second encoded image may be decoded incorrectly. However, due to the use of certain redundant encoding during the encoding stage, for example, when encoding in the plurality of first predetermined regions on the to-be-encoded image, a plurality of second encoded images may be provided on the to-be-processed image, which may achieve an effective information complementarity between the second encoded images; for another example, a BCH error correction code is introduced when encoding the to-be-encoded information, and a check bit is added to the encoding code, which may improve a decoding accuracy in the decoding process. Therefore, by using the above-mentioned encoding method, the second encoded image may have a certain degree of error tolerance when being decoded, thereby improving the decoding accuracy.

According to embodiments of the present disclosure, operation S520 may include; determining a second encoding code corresponding to each of the at least one second predetermined region of the second encoded image, according to at least one second predetermined pixel value, so as to obtain the second encoded information, wherein the at least one second predetermined pixel value corresponds to the at least one second predetermined region of the second encoded image respectively.

According to embodiments of the present disclosure, the second predetermined pixel value may be one or more pixel values pre-configured to be associated with the second encoding code. For example, when the second predetermined pixel value is 0, the corresponding second encoding code may be 0; when the second predetermined pixel value is 85, the corresponding second encoding code may be 1. For another example, when the second predetermined pixel values are 255, 0, 0, 0, the corresponding second encoding code may be 0; when the second predetermined pixel values are 255, 255, 0, 0, the corresponding second encoding code may be 1.

According to embodiments of the present disclosure, the second encoding code is a N-bit code, the N-bit second encoding code includes a N1-bit first encoding code and a N2-bit second encoding code, where N is a positive integer, and N1 and N2 are natural numbers. The determining a second encoding code corresponding to each of the at least one second predetermined region of the second encoded image according to at least one second predetermined pixel value so as to obtain the second encoded information includes: determining the at least one second predetermined region corresponding to the second encoded image and N1 first decoding sub-regions and N2 second decoding sub-regions respectively corresponding to the at least one second predetermined region; and for each second predetermined region in the at least one second predetermined region, the second encoded information is obtained by one of:
obtaining, based on a first decoding strategy, a first decoded information according to a second predetermined pixel value corresponding to each of the N1 first decoding sub-regions and a plurality of second predetermined pixel values respectively corresponding to the N2 second decoding sub-regions; when it is determined that the first decoded information includes a first target decoding code corresponding to each of the N1 first decoding sub-regions and does not include a second target decoding code corresponding to each of the N2 second decoding sub-regions, obtaining, based on a second decoding strategy, a second decoded information according to the plurality of second predetermined pixel values respectively corresponding to the N2 second decoding sub-regions of the second predetermined region; and when it is determined that the second decoded information includes the second target decoding code corresponding to each of the N2 second decoding sub-regions, obtaining the N-bit second encoding code according to a N1-bit first target decoding code and a N2-bit second target decoding code; or
obtaining, based on the second decoding strategy, a third decoded information according to a second predetermined pixel value corresponding to each of the N1 first decoding sub-regions and a plurality of second predetermined pixel values respectively corresponding to the N2 second decoding sub-regions; when it is determined that the third decoded information includes a second target decoding code corresponding to each of the N2 second decoding sub-regions and does not include a first target decoding code corresponding to each of the N1 first decoding sub-regions, obtaining, based on the first decoding strategy, a fourth decoded information according to a second predetermined pixel value corresponding to each of the N1 first decoding sub-regions of the second predetermined region; and when it is determined that the fourth decoded information includes the first target decoding code corresponding to each of the N1 first decoding sub-regions, obtaining a N-bit second encoding code according to the N1-bit first target decoding code and the N2-bit second target decoding code.

According to embodiments of the present disclosure, the first decoding sub-region may be a region for implementing the first decoding strategy; and the second decoding sub-region may be a region for implementing the second decoding strategy. In the second predetermined region, the first decoding sub-region and the second decoding sub-region may exist at the same time, or only the first decoding sub-region or only the second decoding sub-region may exist, which may be adaptively adjusted according to actual needs. Positions of the first decoding sub-region and the second decoding sub-region may be adaptively adjusted according to actual needs.

According to embodiments of the present disclosure, the first decoding code may refer to an encoding code using the first encoding strategy; the second decoding code may refer to an encoding code using the second encoding strategy. Each first decoding code in the first decoding strategy corresponds to the second predetermined pixel value; each second decoding code in the second decoding strategy may correspond to a plurality of second predetermined pixel values. The first decoding strategy may correspond to the first encoding strategy, and the second decoding strategy may correspond to the second encoding strategy.

According to embodiments of the present disclosure, in the process of obtaining the second encoding code according to the second predetermined pixel value, it may be attempted to use the first decoding strategy for decoding first. If a complete second encoding code may be obtained using the first decoding strategy, it is not required to use the second decoding strategy. If the complete second encoding code may not be obtained, the second decoding strategy may be used for decoding. If the second encoding code may not be obtained, the second decoding strategy may be used for decoding.

For example, assuming that the second encoded image is obtained by combining the first encoding strategy and the second encoding strategy, the second encoding code is a 47-bit code. In the 47-bit first encoding code, the 24-bit encoding code representing the device may be the first decoding code, where N1 is 24; the 23-bit encoding code representing the time may be the second decoding code, where N2 is 23;24 first decoding sub-regions and 23 second decoding sub-regions may be provided on the second encoded image. At this time, the first decoding strategy may first be used for decoding, but the result is that only the 24-bit encoding code may be obtained according to pixel values of the 24 first decoding sub-regions. The 24-bit encoding code may be used as the first target decoding code in the first decoding information. Since 24 bits are less than 47 bits, it means that the current second encoded image has not been completely decoded. At this time, the remaining region may be decoded using the second decoding strategy, so as to obtain the 23-bit encoding code. The 23-bit encoding code may be used as the second target decoding code in the second decoding information. In another embodiment, the second decoding strategy may be used to attempt decoding first. If a complete second encoding code may be obtained using the second decoding strategy, it is not required to use the first decoding strategy. If the complete second encoding code may not be obtained, the first decoding strategy may be used for decoding. If the second encoding code may not be obtained, the first decoding strategy may be used for decoding. The example process of first using the second decoding strategy may be similar to the above- mentioned example process of first using the first decoding strategy. For a third decoding information and a fourth decoding information, please refer to the first decoding information and the second decoding information respectively, which will not be repeated here.

According to embodiments of the present disclosure, the second encoding code is a N-bit code, the N-bit second encoding code includes a N1-bit first decoding code and a N2-bit second decoding code, where N is a positive integer, and N1 and N2 are natural numbers; and the determining a second encoding code corresponding to each of the at least one second predetermined region of the second encoded image according to at least one second predetermined pixel value so as to obtain the second encoded information includes: determining at least one second predetermined region corresponding to the second encoded image and N1 first decoding sub-regions and N2 second decoding sub-regions respectively corresponding to the at least one second predetermined region; and for each second predetermined region in the at least one second predetermined region, determining a decoding strategy corresponding to each of the N1 first decoding sub-regions of the second predetermined region and a decoding strategy corresponding to each of N second decoding sub-regions of the second predetermined region, so as to obtain a first decoding strategy corresponding to each of the N1 first decoding sub-regions and a second decoding strategy corresponding to each of the N2 second decoding sub-regions; obtaining, based on the first decoding strategy, a first target decoding code corresponding to each of the N1 first decoding sub-regions according to a second predetermined pixel value corresponding to each of the N1 first decoding sub-regions of the second predetermined region; obtaining, based on the second decoding strategy, a second target decoding code corresponding to each of the N2 second decoding sub-regions according to a plurality of second predetermined pixel values corresponding to each of the N2 second decoding sub-regions of the second predetermined region; and obtaining the N-bit second encoding code according to a N1-bit first target decoding code and a N2-bit second target decoding code.

For example, assuming that N is 4, N1 is 2, and N2 is 2, that is, two first decoding sub-regions and two second decoding sub-regions are provided in the second predetermined region, and the pixel values in the two first decoding sub-regions are 0 and 85 respectively, the first target decoding codes obtained by decoding the two first decoding sub-regions using the first decoding strategy are 0 and 1 respectively. When the pixel values in the two second decoding sub-regions are (255, 0, 0, 0) and (255, 255, 255, 0), the second target decoding codes obtained by decoding the two second decoding sub-regions using the second decoding strategy are 0 and 2 respectively. According to 2-bit first target decoding codes 0, 1 and 2-bit second target decoding codes 0, 2, a 4-bit second encoding code 0102 may be obtained. The second encoding code may also be any other arrangement and combination among arrangement and combinations of the four numbers 0, 1, 0, 2 except 0102. An arrangement order of the obtained second encoding code may be related to a decoding order of the decoding strategy, the decoding order of the decoding strategy may be related to an encoding order of the encoding strategy, and the encoding order may be adaptively adjusted according to actual needs.

According to embodiments of the present disclosure, the plurality of second predetermined pixel values include a first decoding predetermined pixel value and at least one second decoding predetermined pixel value, and the first decoding predetermined pixel value is greater than any one of the at least one second decoding predetermined pixel value; and the obtaining, based on the second decoding strategy, a second target decoding code corresponding to each of the N2 second decoding sub-regions according to a plurality of second predetermined pixel values corresponding to each of the N2 second decoding sub-regions of the second predetermined region includes: for each second decoding sub-region in the N2 second decoding sub-regions, determining a first decoding region in the second decoding sub-region according to a first decoding predetermined pixel value corresponding to the second decoding sub-region; determining a ratio between a size information of the first decoding region and a size information of the second decoding sub-region, so as to obtain a second predetermined ratio corresponding to the second decoding sub-region; and determining a second decoding code corresponding to the second predetermined ratio according to a first predetermined association relationship set, so as to obtain the second target decoding code corresponding to the second predetermined sub-region, where the first predetermined association relationship set includes N2 first predetermined association relationships, and each of the first predetermined association relationships characterizes an association relationship between the second decoding code and the second predetermined ratio.

The first decoding region may refer to a region having a large pixel value. For example, assuming that N is 4, N1 is 0, and N2 is 4, that is, four second decoding sub-regions are provided in the second predetermined region, and the pixel values in the four second decoding sub-regions are (255, 0, 0, 0), (255, 255, 0, 0), (255, 255, 255, 0), and (255, 255, 255, 255). According to these pixel values, it can be seen that in each second predetermined sub-region, the second predetermined ratios of the first decoding region with a large pixel value to the second decoding sub-region are ¼, 2/4, ¾, and 4/4, respectively. From the first predetermined association relationship set, it may be found based on a preset first predetermined association relationship that the encoding codes corresponding to the second predetermined ratios are 0, 1, 2, and 3, respectively.

According to embodiments of the present disclosure, the determining a decoding strategy corresponding to each of the N1 first decoding sub-regions of the second predetermined region and a decoding strategy corresponding to each of N second decoding sub-regions of the second predetermined region, so as to obtain a first decoding strategy corresponding to each of the N1 first decoding sub-regions and a second decoding strategy corresponding to each of the N2 second decoding sub-regions includes: when it is determined that an encoding strategy corresponding to each of the N1 first decoding sub-regions is a first encoding strategy according to a second predetermined association relationship set, determining that the decoding strategy corresponding to each of the N1 first decoding sub-regions is the first decoding strategy, where the second predetermined association relationship set includes N1 second predetermined association relationships, each of the second predetermined association relationships characterizes an association relationship between a first predetermined region identifier and a first predetermined strategy identifier, the first predetermined region identifier is used to characterize the first decoding sub-region, and the first predetermined strategy identifier characterizes that the encoding strategy corresponding to the first decoding sub-region is the first encoding strategy; and when it is determined that an encoding strategy corresponding to each of the N2 second decoding sub-regions is a second encoding strategy according to a third predetermined association relationship set, determining that the decoding strategy corresponding to each of the N2 second decoding sub-regions is the second decoding strategy, where the third predetermined association relationship set includes N2 third predetermined association relationships, each of the third predetermined association relationship characterizes an association relationship between a second predetermined region identifier and a second predetermined strategy identifier, the second predetermined region identifier is used to characterize the second decoding sub-region, and the second predetermined strategy identifier characterizes that the encoding strategy corresponding to the second decoding sub-region is the second encoding strategy.

According to embodiments of the present disclosure, by constructing a relationship between the first predetermined region identifier and the first predetermined strategy identifier, and constructing a relationship between the second predetermined region identifier and the second predetermined strategy identifier, when restoring the encoded information, the information of the corresponding predetermined sub-region may be directly restored using the corresponding decoding strategy according to the identifier and the corresponding decoding strategy. For example, when it is required to decode the second encoded image, the second predetermined association relationship set and the third predetermined association relationship set may be found from the specified list, and a corresponding encoding strategy identifier and a corresponding predetermined region identifier may be obtained from the association relationship set. The specific encoding strategy used is obtained according to the encoding strategy identifier, and then the second encoded image may be decoded by using the decoding strategy corresponding to the encoding strategy.

According to embodiments of the present disclosure, by constructing the second association relationship set and the third association relationship set, the encoding strategy used by the second encoded image and the second predetermined sub-region using the encoding strategy may be quickly distinguished during the process of restoring the information on the second encoded image, so that a corresponding decoding strategy may be found for decoding processing, so as to improve an efficiency of performing the decoding processing on the second encoded image.

According to embodiments of the present disclosure, operation S530 may include; obtaining a plurality of second check codes according to the second encoded information; determining a second to-be-encoded group corresponding to each of the plurality of second check codes, so as to obtain a plurality of second to-be-encoded groups; and obtaining the second to-be-encoded information according to the plurality of second to-be-encoded groups.

According to embodiments of the present disclosure, the above-mentioned operation may be understood as a reverse operation of the BCH encoding. For example, the second check code at the end is removed from the second encoded information, so as to obtain the second to-be-encoded group, and the encoding codes in the second to-be-encoded group are combined according to a predetermined bit, so as to obtain the second to-be-encoded information.

According to embodiments of the present disclosure, by using the BCH encoding method, since the BCH encoding already includes a check bit, it may be used to detect and repair an error of data, which may play a better check role in data transmission and verification scenarios. A decoding accuracy when decoding the encoded information may also be improved by using the BCH encoding method.

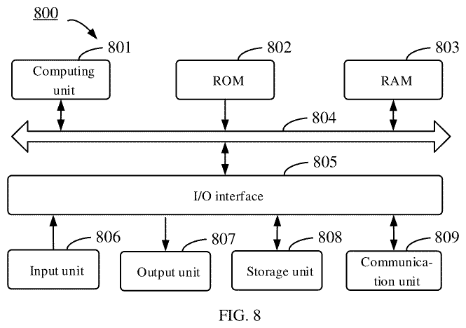

FIG. 7 shows a framework diagram of a method of processing an image according to yet another embodiment of the present disclosure.

As shown in FIG. 7, encoded information 702 may be obtained by encoding a to-be-encoded information 701 corresponding to the display apparatus, an encoded image 704 may be obtained by adjusting a pixel value of a to-be-encoded image 703 according to the encoded information 702, and a fused image 706 may be obtained by fusing the encoded image 704 and the target image 705. A captured image 708 or an exported fused image may be obtained by capturing or exporting the fused image 706 using an electronic device 707 such as a mobile phone, a USB flash drive, etc. When the captured image 708 or the exported fused image is disseminated through the network, and the captured image or the exported fused image is found on the network, the decoding processing may be performed on the captured image or the exported fused image, and the to-be-encoded information 701 corresponding to the display apparatus may be obtained. What time the captured image was leaked, which device the captured image was leaked from, and the geographical location of the leak may be known.

According to embodiments of the present disclosure, for the processing process shown in FIG. 7, please refer to the relevant contents in operations S110 to S130 and operations S510 to S530, which will not be repeated in detail in the present disclosure.

According to embodiments of the present disclosure, the present disclosure further provides an electronic device, a readable storage medium and a computer program product.

According to embodiments of the present disclosure, there is provided an electronic device includes: at least one processor; and a memory communicatively connected to the at least one processor; where the memory stores instructions executable by the at least one processor, and the instructions are used to, when executed by the at least one processor, cause the at least one processor to implement the method as described above.

According to embodiments of the present disclosure, there is provided a non- transitory computer-readable storage medium having computer instructions, where the computer instructions are used to cause a computer to execute the method as described above.

According to embodiments of the present disclosure, there is provided a computer program product including a computer program, and the computer program is used to, when executed by a processor, implement the method as described above.

FIG. 8 shows a block diagram of an electronic device suitable for implementing a method of processing an image according to embodiments of the present disclosure. The electronic device is intended to represent various forms of digital computers, such as a laptop computer, a desktop computer, a workstation, a personal digital assistant, a server, a blade server, a mainframe computer, and other appropriate computers. The electronic device may also represent various forms of mobile devices, such as a personal digital assistant, a cellular phone, smart phones, a wearable device, and other similar computing devices. The components shown herein, their connections and relationships, and their functions are only examples, and are not intended to limit the implementation of the present disclosure described and/or claimed herein.

As shown in FIG. 8, an electronic device 800 includes a computing unit 801, which may perform various appropriate actions and processes according to a computer program stored in a read-only memory (ROM) 802 or a computer program loaded from a storage unit 808 to a random access memory (RAM) 803. In the RAM 803, various programs and data required for the operation of the electronic device 800 may also be stored. The computing unit 801, the ROM 802, and the RAM 803 are connected to one another via a bus 804. An input/output (I/O) interface 805 is also connected to the bus 804.

A plurality of components in the electronic device 800 are connected to the I/O interface 805, including: an input unit 806, such as a keyboard, a mouse, etc.; an output unit 807, such as various types of displays, speakers, etc.; a storage unit 808, such as a disk, an optical disk, etc.; and a communication unit 809, such as a network card, a modem, a wireless communication transceiver, etc. The communication unit 809 allows the electronic device 800 to exchange information/data with other devices through a computer network such as the Internet and/or various telecommunication networks.

The computing unit 801 may be various general and/or special processing components having processing and computing capabilities. Some examples of the computing unit 801 include, but are not limited to, a central processing unit (CPU), a graphics processing unit (GPU), various dedicated artificial intelligence (AI) computing chips, various computing units that run machine learning model algorithms, a digital signal processor (DSP), and any appropriate processor, controller, microcontroller, etc. The computing unit 801 executes the various methods and processes as described above, for example, the method of processing an image. For example, in some embodiments, the method of processing an image may be implemented as a computer software program, which is tangibly embodied in a machine-readable medium, such as the storage unit 808. In some embodiments, part or all of the computer programs may be loaded and/or installed on the electronic device 800 via the ROM 802 and/or the communication unit 809. When the computer program is loaded into the RAM 803 and executed by the computing unit 801, one or more steps of the method of processing an image as described above may be performed. Alternatively, in other embodiments, the computing unit 801 may be configured to perform the method of processing an image in any other appropriate manner (e.g., by means of firmware).

Various embodiments of the systems and techniques as described above herein may be implemented in a digital electronic circuit system, an integrated circuit system, a field programmable gate array (FPGA), an application specific integrated circuit (ASIC), an application specific standard product (ASSP), a system on chip (SOC), a complex programmable logic device (CPLD), a computer hardware, firmware, software, and/or a combination thereof. These various embodiments may include; being implemented in one or more computer programs that may be executed and/or interpreted on a programmable system including at least one programmable processor, where the programmable processor may be a special purpose or general purpose programmable processor that may receive data and instructions from a storage system, at least one input apparatus, and at least one output apparatus, and transmit data and instructions to the storage system, the at least one input device, and the at least one output device.

Program codes for implementing the method of the present disclosure may be written in any combination of one or more programming languages. These program codes may be provided to a processor or controller of a general-purpose computer, a special-purpose computer or other programmable data mining device, so that when the program codes are executed by the processor or controller, the functions/operations specified in the flowcharts and/or block diagrams are implemented. The program codes may be executed entirely on the machine, partly on the machine, partly on the machine and partly on a remote machine as a stand-alone software package, or entirely on the remote machine or server.

In the context of the present disclosure, the machine-readable medium may be a tangible medium that may contain or store a program for use by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM or flash memory), an optical fiber, a portable compact disk-read-only memory (CD-ROM), an optical storage device, a magnetic storage device, or any appropriate combination thereof.

In order to provide interaction with a user, the systems and techniques described herein may be implemented on a computer, including: a display apparatus (e.g., a CRT (cathode ray tube) or LCD (liquid crystal display) monitor) for displaying information to the user; and a keyboard and a pointing apparatus (e.g., a mouse or trackball) through which the user may provide input to the computer. Other types of devices may also be used to provide interaction with the user; for example, a feedback provided to the user may be any form of sensory feedback (e.g., a visual feedback, an auditory feedback, or a tactile feedback); and input from the user may be received in any form (including an acoustic input, a voice input, or a tactile input).

The systems and techniques described herein may be implemented in a computing system (e.g., as a data server) including back-end components, or a computing system (e.g., an application server) including middleware components, or a computing system (e.g., a user computer with a graphical user interface or a web browser through which a user may interact with embodiments of the systems and techniques described herein) including front-end components, or a computing system including any combinations of such back-end components, middleware components, or front-end components. The components of the system may be interconnected by any form or medium of digital data communication (e.g., a communication network). Examples of the communication network include; a local region network (LAN), a wide region network (WAN), and the Internet.

The computer system may include a client and a server. The client and the server are generally far away from each other and typically interact with each other through the communication network. A relationship between the client and the server is generated by a computer program running on a corresponding computer and having a client-server relationship with each other. The server may be a cloud server, a distributed system server, or a server combined with a blockchain.

It should be understood that the steps may be reordered, added or deleted by using various forms of the processes shown above. For example, the steps described in the present disclosure may be executed in parallel, sequentially, or in different orders, as long as the desired results of the technical solutions disclosed in the present disclosure may be achieved, which will not be limited in the present disclosure.

The above-mentioned specific implementations do not constitute a limitation on the scope of protection of the present disclosure. Those skilled in the art may understand that various modifications, combinations, sub-combinations and substitutions may be made according to design requirements and other factors. Any modifications, equivalent substitutions and improvements made within the spirit and principles of the present disclosure should be included in the scope of protection of the present disclosure.

1. A method of processing an image, comprising:
encoding a first to-be-encoded information corresponding to a display apparatus, so as to obtain a first encoded information;
adjusting a pixel value of at least one first predetermined region of a to-be-encoded image according to the first encoded information, so as to obtain a first encoded image, wherein the to-be-encoded image corresponds to a target image; and
fusing the target image with the first encoded image to obtain a fused image.

2. The method according to claim 1, wherein the first encoded information comprises a first encoding code of at least one bit; and
wherein the adjusting a pixel value of at least one first predetermined region of a to-be-encoded image according to the first encoded information so as to obtain a first encoded image comprises:
adjusting the pixel value of the at least one first predetermined region of the to-be-encoded image according to at least one first predetermined pixel value, so as to obtain the first encoded image, wherein at least one first predetermined region of the first encoded image comprises the at least one first predetermined pixel value, and the at least one first predetermined pixel value corresponds to the at least one bit of the first encoding code respectively.

3. The method according to claim 2, wherein the first encoding code is a N-bit code, where N is a positive integer; and
wherein the adjusting the pixel value of the at least one first predetermined region of the to-be-encoded image according to at least one first predetermined pixel value so as to obtain the first encoded image comprises; for each of the at least one first predetermined region, dividing the first predetermined region into N first predetermined sub-regions,
wherein the N first predetermined sub-regions comprise N1 first encoding sub-regions and N2 second encoding sub-regions, the N-bit first encoding code comprises a N1-bit first encoding code and a N2-bit second encoding code, where N1 and N2 are natural numbers, each bit of the N1-bit first encoding code corresponds to one first predetermined pixel value, and each bit of the N2-bit second encoding code corresponds to more than one first predetermined pixel values;
adjusting, based on a first encoding strategy, pixel values of the N1 first encoding sub-regions of the to-be-encoded image according to the first predetermined pixel value corresponding to each bit of the N1-bit first encoding code, so as to obtain N1 first encoding region images;
adjusting, based on a second encoding strategy, pixel values of the N2 second encoding sub-regions of the to-be-encoded image according to the first predetermined pixel values corresponding to each bit of the N2-bit second encoding code, so as to obtain N2 second encoding region images; and
obtaining the first encoded image according to the N1 first encoding region images and the N2 second encoding region images.

4. The method according to claim 3, wherein the adjusting, based on a first encoding strategy, pixel values of the N1 first encoding sub-regions of the to-be-encoded image according to a first predetermined pixel value corresponding to the N1-bit first encoding code so as to obtain N1 first encoding region images comprises; for each of the N1 first encoding sub-regions,
determining a first encoding code corresponding to the first encoding sub-region, so as to obtain a first target encoding code corresponding to the first encoding sub-region; and
adjusting the pixel value of the first encoding sub-region to the first predetermined pixel value corresponding to the first target encoding code, so as to obtain the first encoding region image corresponding to the first encoding sub-region.

5. The method according to claim 3, wherein the first predetermined pixel values comprise a first predetermined encoding pixel value and at least one second predetermined encoding pixel value, and the first predetermined encoding pixel value is greater than the at least one second predetermined encoding pixel value; and
wherein the adjusting, based on a second encoding strategy, pixel values of the N2 second encoding sub-regions of the to-be-encoded image according to the first predetermined pixel values corresponding to the N2-bit second encoding code so as to obtain N2 second encoding region images comprises; for each of the N2 second encoding sub-regions,
determining a second encoding code corresponding to the second encoding sub-region, so as to obtain a second target encoding code corresponding to the second encoding sub-region;
determining a first predetermined ratio corresponding to the second target encoding code according to a first predetermined association relationship set, wherein the first predetermined association relationship set comprises N2 first predetermined association relationships, and each of the first predetermined association relationships characterizes an association relationship between the second encoding code and the first predetermined ratio; and
adjusting a pixel value of a first encoding region in the second encoding sub-region to the first predetermined encoding pixel value according to the first predetermined ratio, and adjusting a pixel value of a second encoding region in the second encoding sub-region to the at least one second predetermined encoding pixel value according to the first predetermined ratio, so as to obtain the second encoding region image corresponding to the second encoding sub-region, wherein a ratio between a size information of the first encoding region and a size information of the second encoding sub-region is the first predetermined ratio.

6. The method according to claim 3, further comprising:
determining a second predetermined association relationship corresponding to each of the N1 first encoding sub-regions, so as to obtain a second predetermined association relationship set, wherein the second predetermined association relationship set comprises N1 second predetermined association relationships, each of the second predetermined association relationships characterizes an association relationship between a first predetermined region identifier and a first predetermined strategy identifier, the first predetermined region identifier is used to characterize the first encoding sub-region, and the first predetermined strategy identifier characterizes that an encoding strategy corresponding to the first encoding sub-region is the first encoding strategy;
determining a third predetermined association relationship corresponding to each of the N2 second encoding sub-regions, so as to obtain a third predetermined association relationship set, wherein the third predetermined association relationship set comprises N2 third predetermined association relationships, each of the third predetermined association relationship characterizes an association relationship between a second predetermined region identifier and a second predetermined strategy identifier, the second predetermined region identifier is used to characterize the second encoding sub-region, and the second predetermined strategy identifier characterizes that an encoding strategy corresponding to the second encoding sub-region is the second encoding strategy; and
storing the second predetermined association relationship set and the third predetermined association relationship set.

7. The method according to claim 1, wherein the first to-be-encoded information comprises a multi-bit first to-be-encoded code; and
wherein the encoding a first to-be-encoded information corresponding to a display apparatus so as to obtain a first encoded information comprises; dividing the multi-bit first to-be-encoded code into a plurality of first to-be-encoded groups;
determining a first check code corresponding to each of the plurality of first to-be-encoded groups, so as to obtain a plurality of first check codes; and
obtaining the first encoded information according to the multi-bit first to-be-encoded code and the plurality of first check codes.

8. The method according to claim 1, wherein the fusing the target image with the first encoded image to obtain a fused image comprises;
determining a product between a pixel value of each of at least one pixel comprised in the target image and a first predetermined coefficient, so as to obtain a first pixel information;
determining a product between a pixel value of each of at least one pixel comprised in the first encoded image and a second predetermined coefficient, so as to obtain a second pixel information;
obtaining a third pixel information according to the first pixel information and the second pixel information; and
obtaining the fused image according to the third pixel information.

9. The method according to claim 1, wherein a shape of the first predetermined region comprises at least one of: a rectangle, a square, a diamond, a triangle or a circle.

10. The method according to claim 3, wherein a shape of the first encoding sub-region comprises at least one of: a rectangle, a square, a diamond, a triangle or a circle; and
a shape of the second encoding sub-region comprises at least one of: a rectangle, a square, a diamond, a triangle or a circle.

11. The method according to claim 1, wherein the first to-be-encoded information comprises at least one of: a device identifier, a time displayed on the display apparatus or a geographical location.

12. A method of processing an image, comprising:
processing a to-be-processed image to obtain a second encoded image, wherein the to-be-processed image comprises one of: a fused image or a captured image corresponding to the fused image, and the fused image is obtained by the method according to claim 1;
obtaining a second encoded information according to a pixel value of at least one second predetermined region of the second encoded image; and
decoding the second encoded information to obtain a second to-be-encoded information corresponding to a display apparatus.

13. The method according to claim 12, wherein the obtaining second encoded information according to a pixel value of at least one second predetermined region of the second encoded image comprises:
determining a second encoding code corresponding to each of the at least one second predetermined region of the second encoded image, according to at least one second predetermined pixel value, so as to obtain the second encoded information, wherein the at least one second predetermined pixel value corresponds to the at least one second predetermined region of the second encoded image respectively.

14. The method according to claim 13, wherein the second encoding code is a N-bit code, the N-bit second encoding code comprises a N1-bit first encoding code and a N2-bit second encoding code, where N is a positive integer, and N1 and N2 are natural numbers;
wherein the determining a second encoding code corresponding to each of the at least one second predetermined region of the second encoded image according to at least one second predetermined pixel value so as to obtain the second encoded information comprises;
determining the at least one second predetermined region corresponding to the second encoded image and N1 first decoding sub-regions and N2 second decoding sub-regions respectively corresponding to the at least one second predetermined region; and
for each of the at least one second predetermined region, obtaining the second encoded information by:
obtaining, based on a first decoding strategy, a first decoded information according to a second predetermined pixel value corresponding to each of the N1 first decoding sub-regions and a plurality of second predetermined pixel values respectively corresponding to the N2 second decoding sub-regions; when it is determined that the first decoded information comprises a first target decoding code corresponding to each of the N1 first decoding sub-regions and does not comprise a second target decoding code corresponding to each of the N2 second decoding sub-regions, obtaining, based on a second decoding strategy, a second decoded information according to the plurality of second predetermined pixel values respectively corresponding to the N2 second decoding sub-regions of the second predetermined region; and when it is determined that the second decoded information comprises the second target decoding code corresponding to each of the N2 second decoding sub-regions, obtaining the N-bit second encoding code according to a N1-bit first target decoding code and a N2-bit second target decoding code; or
obtaining, based on the second decoding strategy, a third decoded information according to a second predetermined pixel value corresponding to each of the N1 first decoding sub-regions and a plurality of second predetermined pixel values respectively corresponding to the N2 second decoding sub-regions; when it is determined that the third decoded information comprises a second target decoding code corresponding to each of the N2 second decoding sub-regions and does not comprise a first target decoding code corresponding to each of the N1 first decoding sub-regions, obtaining, based on the first decoding strategy, a fourth decoded information according to a second predetermined pixel value corresponding to each of the N1first decoding sub-regions of the second predetermined region; and when it is determined that the fourth decoded information comprises the first target decoding code corresponding to each of the N1 first decoding sub-regions, obtaining a N-bit second encoding code according to the N1-bit first target decoding code and the N2-bit second target decoding code.

15. The method according to claim 13, wherein the second encoding code is a N-bit code, the N-bit second encoding code comprises a N1-bit first decoding code and a N2-bit second decoding code, where N is a positive integer, and N1 and N2 are natural numbers; and
wherein the determining a second encoding code corresponding to each of the at least one second predetermined region of the second encoded image according to at least one second predetermined pixel value so as to obtain the second encoded information comprises;
determining at least one second predetermined region corresponding to the second encoded image and N1 first decoding sub-regions and N2 second decoding sub-regions respectively corresponding to the at least one second predetermined region; and
for each of the at least one second predetermined region,
determining a decoding strategy corresponding to each of the N1 first decoding sub-regions of the second predetermined region and a decoding strategy corresponding to each of N second decoding sub-regions of the second predetermined region, so as to obtain a first decoding strategy corresponding to each of the N1 first decoding sub-regions and a second decoding strategy corresponding to each of the N2 second decoding sub-regions;
obtaining, based on the first decoding strategy, a first target decoding code corresponding to each of the N1 first decoding sub-regions according to a second predetermined pixel value corresponding to each of the N1 first decoding sub-regions of the second predetermined region;
obtaining, based on the second decoding strategy, a second target decoding code corresponding to each of the N2 second decoding sub-regions according to a plurality of second predetermined pixel values corresponding to each of the N2 second decoding sub-regions of the second predetermined region; and
obtaining the N-bit second encoding code according to a N1-bit first target decoding code and a N2-bit second target decoding code.

16. The method according to claim 15, wherein the plurality of second predetermined pixel values comprise a first decoding predetermined pixel value and at least one second decoding predetermined pixel value, and the first decoding predetermined pixel value is greater than any one of the at least one second decoding predetermined pixel value; and
wherein the obtaining, based on the second decoding strategy, a second target decoding code corresponding to each of the N2 second decoding sub-regions according to a plurality of second predetermined pixel values corresponding to each of the N2 second decoding sub-regions of the second predetermined region comprises; for each of the N2 second decoding sub-regions,
determining a first decoding region in the second decoding sub-region according to a first decoding predetermined pixel value corresponding to the second decoding sub-region;
determining a ratio between a size information of the first decoding region and a size information of the second decoding sub-region, so as to obtain a second predetermined ratio corresponding to the second decoding sub-region; and
determining a second decoding code corresponding to the second predetermined ratio according to a first predetermined association relationship set, so as to obtain the second target decoding code corresponding to the second predetermined sub-region, wherein the first predetermined association relationship set comprises N2 first predetermined association relationships, and each of the first predetermined association relationships characterizes an association relationship between the second decoding code and the second predetermined ratio.

17. The method according to claim 15, wherein the determining a decoding strategy corresponding to each of the N1 first decoding sub-regions of the second predetermined region and a decoding strategy corresponding to each of N second decoding sub-regions of the second predetermined region, so as to obtain a first decoding strategy corresponding to each of the N1 first decoding sub-regions and a second decoding strategy corresponding to each of the N2 second decoding sub-regions comprises;
when it is determined that an encoding strategy corresponding to each of the N1 first decoding sub-regions is a first encoding strategy according to a second predetermined association relationship set, determining that the decoding strategy corresponding to each of the N1 first decoding sub-regions is the first decoding strategy, wherein the second predetermined association relationship set comprises N1 second predetermined association relationships, each of the second predetermined association relationships characterizes an association relationship between a first predetermined region identifier and a first predetermined strategy identifier, the first predetermined region identifier is used to characterize the first decoding sub-region, and the first predetermined strategy identifier characterizes that the encoding strategy corresponding to the first decoding sub-region is the first encoding strategy; and
when it is determined that an encoding strategy corresponding to each of the N2 second decoding sub-regions is a second encoding strategy according to a third predetermined association relationship set, determining that the decoding strategy corresponding to each of the N2 second decoding sub-regions is the second decoding strategy, wherein the third predetermined association relationship set comprises N2 third predetermined association relationships, each of the third predetermined association relationship characterizes an association relationship between a second predetermined region identifier and a second predetermined strategy identifier, the second predetermined region identifier is configured to characterize the second decoding sub-region, and the second predetermined strategy identifier characterizes that the encoding strategy corresponding to the second decoding sub-region is the second encoding strategy.

18. The method according to claim 12, wherein the decoding the second encoded information to obtain second to-be-encoded information corresponding to a display apparatus comprises:
obtaining a plurality of second check codes according to the second encoded information;
determining a second to-be-encoded group corresponding to each of the plurality of second check codes, so as to obtain a plurality of second to-be-encoded groups; and
obtaining the second to-be-encoded information according to the plurality of second to-be-encoded groups;
wherein the processing a to-be-processed image to obtain a second encoded image comprises: obtaining a feature map of at least one scale according to the to-be-processed image; and obtaining the second encoded image according to the feature map of the at least one scale;
wherein the at least one scale comprises J scales, where J is a positive integer; and
wherein the obtaining the second encoded image according to the feature map of the at least one scale comprises; in a case of 1≤j<J, obtaining a fused feature map of a j^{th} scale according to the feature map of the j^{th} scale and an upsampled feature map of the j^{th} scale, wherein the upsampled feature map of the j^{th} scale is obtained according to the feature map of a (j+1)^{th} scale and an upsampled feature map of the (j+1)^{th} scale, and the feature map of the j^{th} scale is obtained according to the feature map of a (j−1)^{th} scale, where j is an integer greater than or equal to 1 and less than or equal to J; and obtaining the second encoded image according to a fused feature map of a 1^{st} scale.

19. (canceled)

20. (canceled)

21. An electronic device, comprising:
one or more processors; and
a memory configured to store one or more programs,
wherein the one or more programs are configured to, when executed by the one or more processors, cause the one or more processors to implement the method according to claim 1.

22. A computer-readable storage medium having executable instructions stored thereon, wherein the instructions are configured to, when executed by a processor, cause the processor to implement the method according to claim 1.

23. (canceled)
